(19) United States
(12) Patent Application Publication
(10) Pub. No.: US 2012/0264095 A1
(43) Pub. Date: Oct. 18, 2012

(54) EMOTION ABREACTION DEVICE AND USING METHOD OF EMOTION ABREACTION DEVICE

(75) Inventors: Hung-Hsiu Yu, Changhua County (TW); Yi-Yi Yu, Kaohsiung City (TW); Ching-Yi Liu, Taichung City (TW); Kuo-Feng Hung, Taoyuan County (TW)

(73) Assignee: INDUSTRIAL TECHNOLOGY RESEARCH INSTITUTE, Hsinchu (TW)

(21) Appl. No.: 13/531,598

(22) Filed: Jun. 25, 2012

Related U.S. Application Data
(63) Continuation-in-part of application No. 11/696,189, filed on Apr. 4, 2007.

(30) Foreign Application Priority Data
Dec. 29, 2006 (TW) 95149995

(51) Int. Cl. G09B 19/00

(52) U.S. Cl. 434/236

(57) ABSTRACT

An emotion abreaction device including a body, a control unit, a man machine interacting module and an emotion abreaction unit is provided. The control unit, the man machine interacting module and the emotion abreaction unit are disposed in the body. The man machine interacting module is electrically connected to the control unit for the user to select an emotion abreaction mode. The emotion abreaction unit is electrically connected to the control unit and has at least one sensor to measure force and/or volume for the user to abreact by knocking and/or yelling. Moreover, a using method of an emotion abreaction device includes turning on the emotion abreaction device, and then, responding to the user with a voice and/or an image according to the sensing result of the magnitude of the volume and/or the force after the user knocks and/or yells to an emotion abreaction unit of the emotion abreaction device.

### CROSS-REFERENCE TO RELATED APPLICATION

This application is a continuation-in-part of and claims the priority benefit of U.S. application Ser. No. 11/696,189, filed on Apr. 4, 2007, now pending, which claims the priority benefit of Taiwan application serial no. 95149995, filed on Dec. 29, 2006. The entirety of each of the above-mentioned patent applications is hereby incorporated by reference herein and made a part of this specification.

### BACKGROUND

1. Technical Field

The present disclosure relates to an emotion abreaction device and the using method of the emotion abreaction device.

2. Related Art

It's difficult to be a modern office staff, as the competition in the companies is very stressful, and it has a high requirement for the life quality. A survey shows that, nearly 8 out of 10 office staffs feel deeply depressed, and 2 of them even have the idea of committing suicide. Since modern people lack of the appropriate and correct means for abreaction, social phenomena such as melancholia, family violence, and alcohol abuse occurred accordingly also demand great attentions. Therefore, how to establish an appropriate and correct means for emotion abreaction has become a researching subject deserving great efforts.

Japanese Patent Publication No. 2005-185630 discloses an emotion mitigation system, which analyzes the noises received from a baby or an animal to determine whether it is in an emotionally nervous state. If the baby or animal is determined to be in an emotionally nervous state, the system will mitigate its nervous emotion through sounds, remotely-controlled toys, and remotely-controlled lamp lights. Japanese Patent Publication No. 2006-123136 discloses a communication robot, which analyzes the emotion state of the caller by retrieving his/her facial image and voice. If the caller is determined to be in an emotionally nervous state, the robot mitigates the caller's nervous emotion by way of singing a song and the like.

### SUMMARY

Accordingly, an exemplary embodiment of present disclosure is directed to an emotion abreaction device with preferred emotion mitigation and abreaction effects.

An exemplary embodiment of present disclosure is also directed to a using method of an emotion abreaction device with preferred emotion mitigation and abreaction effects.

An exemplary embodiment of the present disclosure provides an emotion abreaction device, which comprises a body, a control unit, a man machine interacting module, an image input unit and an emotion abreaction unit, wherein the control unit, the man machine interacting module, the image input unit, and the emotion abreaction unit are disposed in the body. The man machine interacting module is electrically connected to the control unit for the user to input commands to the control unit, which commands comprise selecting an emotion abreaction mode. The emotion abreaction unit is electrically connected to the control unit and has at least one sensor to measure force and/or volume, for the user to abreact his or her emotions by way of knocking and/or yelling. The emotion abreaction unit delivers a sensing result to the control unit, and the control unit controls the man machine interacting module to respond to the user with at least one of a voice and an image based on the sensing result. The image input unit is electrically connected to the control unit, and if configured to capture a first image of the user. A plurality of training images are grouped into a plurality of angle sets according to a light angle of each of the training images. In addition, an intensity of each of the training images changes based on the light angles. The control unit obtains a target grey level according to an average grey level of one of the angle sets. The control unit further obtains a feature value of the first image, adjusts the feature value according to the target grey level, detects a face part of the first image according to the adjusted feature value, and recognizes the face part.

An exemplary embodiment of the present disclosure provides a using method of an emotion abreaction device, which comprises: capturing a first image of a user; obtaining a target grey level, wherein a plurality of training images are grouped into a plurality of angle sets according to a light angle of each of the training images, and the target grey level is obtained according to an average grey level of one of the angle sets, wherein an intensity of each of the training images changes based on the light angles; obtaining a feature value of the first image, adjusting the feature value according to the target grey level, detecting a face part of the first image according to the adjusted feature value, and recognizing the face part. The using method further comprises: when a user knocks the emotion abreaction unit of the emotion abreaction device, measuring a magnitude of the user's knocking force, then responding to the user with at least one of a voice and an image based on the measured magnitude of the force; when the user yells to the emotion abreaction unit of the emotion abreaction device, measuring the magnitude of the volume of the user's yelling, and then responding to the user with at least one of a voice and an image based on the measured magnitude of the volume.

It is to be understood that both the foregoing general description and the following detailed description are exemplary, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIGS. 1A and 1B are respectively a front view and a side view of an emotion abreaction device according to an embodiment of the present disclosure.

FIGS. 2A and 2B are respectively a front view and a side view of an emotion abreaction device according to another embodiment of the present disclosure.

FIG. 3 is the flow chart of a using method of an emotion abreaction device according to an embodiment of the present disclosure.

FIGS. 4A and 4B are schematic block diagrams of an emotion abreaction device according to the second embodiment.

FIG. 5 is a diagram illustrating an example of grouping the training images according to the second embodiment.

FIG. 6 is a diagram of an example of an image captured by the image input unit 170 according to the second embodiment.

FIG. 7 is a diagram of an example illustrating haar-like features according to the second embodiment.

FIGS. 8 and 9 are diagrams illustrating an example of face parts according to the second embodiment.

FIG. 10 is a diagram illustrating an example of a symmetrical rectangle according to the second embodiment.

FIG. 11 is a diagram illustrating an example of detecting corners of a mouth by the symmetrical rectangle according to the second embodiment.

FIG. 12 is a flow chart of a using method for an emotion abreaction device according to the second embodiment.

FIG. 13 is a flow chart of a using method for an emotion abreaction device according to one embodiment.

### DESCRIPTION OF EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### First Embodiments

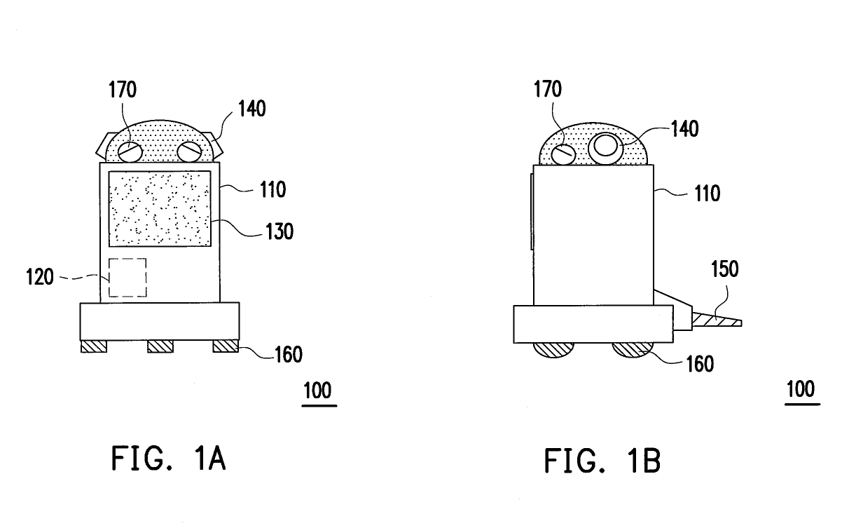

FIGS. 1A and 1B are respectively a front view and a side view of an emotion abreaction device according to an embodiment of the present disclosure. Referring to FIGS. 1A and 1B, the emotion abreaction device 100 of this embodiment includes a body 110, a control unit 120, a man machine interacting module 130, and two emotion abreaction units (including a yelling abreaction unit 140 and a knocking abreaction unit 150). The body 110 is mainly provided for the control unit 120, the man machine interacting module 130, the yelling abreaction unit 140, and the knocking abreaction unit 150 to be disposed thereon. Of course, the body 110 may assume an appearance design with personification or objectification features, in order to further improve the scenario abreaction effects. The man machine interacting module 130, the yelling abreaction unit 140, and the knocking abreaction unit 150 are all electrically connected to the control unit 120. The man machine interacting module 130 is used for the user to input commands to the control unit 120, which commands comprise selecting an emotion abreaction mode. The commands inputted to the man machine interacting module 130 may used for choosing modes or confirming/canceling the operation to be performed. The emotion abreaction unit, which includes the yelling abreaction unit 140 and the knocking abreaction unit 150, delivers a sensing result to the control unit 120. The control unit 120 then controls the man machine interacting module 130 to respond to the user with at least one of a voice and an image based on the sensing result.

Although the emotion abreaction device 100 of this embodiment includes two emotion abreaction units of the yelling abreaction unit 140 and the knocking abreaction unit 150, it may optionally be configured with only the yelling abreaction unit 140 or the knocking abreaction unit 150. The yelling abreaction unit 140 has a volume sensor (not shown), which enables the user to abreact the emotions by way of yelling, and the volume sensor is also commonly referred as decibel meter. The knocking abreaction unit 150 has a force sensor (not shown), which enables the user to abreact the emotions by way of knocking, and the force sensor may be an accelerometer.

Since the emotion abreaction device 100 has the yelling abreaction unit 140 and the knocking abreaction unit 150, it enables the user to abreact the emotions through a relatively furious process, such as yelling or knocking etc, thereby achieving preferred effects in emotion mitigation and abreaction. Furthermore, the emotion abreaction device 100 can also measure the magnitude of the volume of the yelling and that of the knocking force of the user, and thereby responding to the user according to the measured results, and thus providing the user with a bi-directional interaction scenario and feeling during his or her emotion abreaction. Thus, the emotion mitigation and abreaction effect is further improved.

Other alternative variations in the emotion abreaction device 100 of this embodiment are described below with reference to FIGS. 1A and 1B. The emotion abreaction device 100 may further include a moving unit 160 disposed in the body 110 and electrically connected to the control unit 120, which can move the body 110 based on the instruction of the control unit 120. The man machine interacting module 130 may include a touch screen, which provides image displaying and command inputting functions, and the image for being displayed may be built in or externally input. In addition, the emotion abreaction device 100 may further include an image input unit 170 disposed in the body 110 and electrically connected to the control unit 120, such that the man machine interacting module 130 can display the image input from the image input unit 170. Alternatively, the man machine interacting module 130 may include a screen and a command input device (not shown), and similarly, the screen of the man machine interacting module 130 can display the image input from the image input unit 170. The command input device of the man machine interacting module 130 may be a keyboard, a mouse, a touch pad, or another suitable command input device. Of course, the man machine interacting module 130 may also include a speaker (not shown) to provide voice interaction.

Furthermore, the image input unit 170 may also be used as an object detector, for detecting the approaching or departing of the user, and thereby automatically turning on or turning off the emotion abreaction device 100. Of course, the object detector may be an infrared detector or other suitable detectors. Although the image input unit 170 may be an image capturing device such as charge coupled device (CCD), it may alternatively be a card reader, an optical disk drive, a universal serial bus (USB), a blue-tooth transmission module, or any component that enables the user to input images into the emotion abreaction device 100 from an external device. Moreover, the emotion abreaction device 100 may be driven by various energies such as an internal battery, an externally-connected power source, or a solar cell.

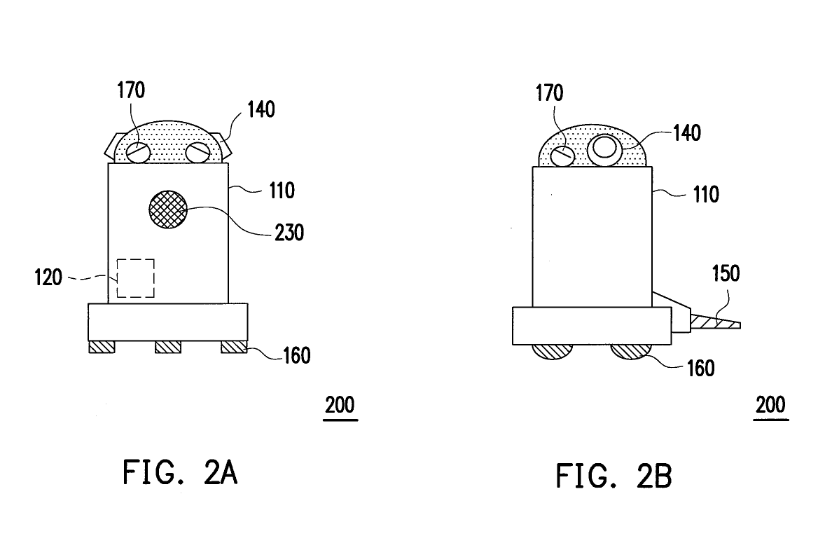

FIGS. 2A and 2B are respectively a front view and a side view of an emotion abreaction device according to another embodiment of the present disclosure. Referring to FIGS. 2A and 2B, the emotion abreaction device 200 of this embodiment is similar to the emotion abreaction device 100 of FIG. 1A, and only the differences there-between are described herein. The man machine interacting module 230 of the emotion abreaction device 200 includes a voice control interface. That is, the man machine interacting module 230 enables the user to interact with the control unit 120 via voices. Specifically, the control unit 120 can control the man machine interacting module 230 to greet the user or provide user with function options through voices, and determines and executes the voice command received by the man machine interacting module 230, and further controls the man machine interacting module 230 to respond to the user through voices. Furthermore, the emotion abreaction device 200 is additionally disposed with a screen (not shown) merely for displaying, which is disposed in the body 110 and electrically connected to the control unit 120. The screen not only can be used to interact with the user by way of images, but display the image input from the image input unit 170.

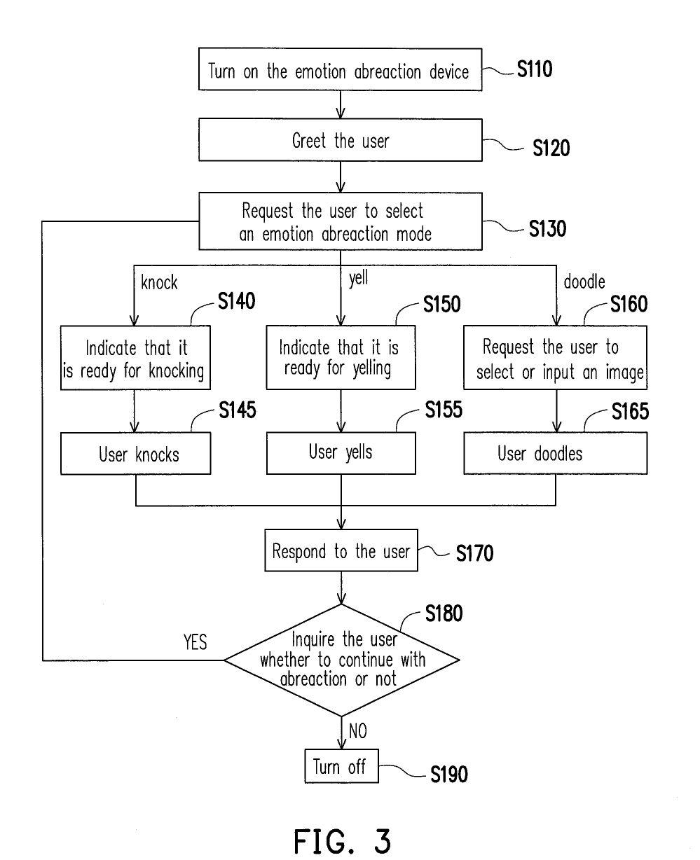

FIG. 3 is a flow chart of a using method of an emotion abreaction device according to an embodiment of the present disclosure. The using method of an emotion abreaction device of this embodiment is applicable for the emotion abreaction device 100 of FIG. 1A, the emotion abreaction device 200 of FIG. 2A, or other emotion abreaction devices capable of performing this method.

Referring to FIGS. 1A, 1B, and 3, the using method of the emotion abreaction device includes the following steps: firstly, the emotion abreaction device 100 is turned on, in step S110. The process for turning on the emotion abreaction device 100 includes manually turning on by a user, or automatically turning on by an object detector (for example, the image input unit 170) upon detecting the approaching of a user.

Next, in step S120, the user is selectively greeted with voice and/or image immediately after the emotion abreaction device has been turned on. For example, a greeting voice of “Good day, master, would you like to abreact your emotions?” is given out, or a greeting image is displayed, or both of the above voices and images are used.

Then, the user is selectively requested to choose at least one emotion abreaction mode from knocking and yelling, in step S130. For example, a voice of “Please select” is given out, or a menu image is displayed, or both of the above voices and images are used. If the emotion abreaction device 100 has a touch screen (for example, the man machine interacting module 130), it can further provide an option of doodling to the user. The process for providing the options to the user includes providing voice options or displayed on the screen, depending on whether the emotion abreaction device 100 has a unit for giving out voices or displaying pictures or not. Similarly, the user can select by means of providing voice commands, pressing keys, or pressing a touch screen, depending on the type of the command input interface provided by the man machine interacting module 130 of the emotion abreaction device 100. Of course, the emotion abreaction device 100 and the user may use other suitable means to provide options and select the options respectively.

If the user has selected to abreact the emotions by means of knocking, the user may be selectively indicated when to knock, in step S140. For example, the voice “5, 4, 3, 2, 1, please beat me!” is played, or a counting-down image is displayed, or both of the above voices and images are used. Then, when the user knocks the knocking abreaction unit 150 of the emotion abreaction unit 100, in step S145, the magnitude of the user's knocking force is measured.

If the user has selected to abreact the emotions by means of yelling, the user may be selectively indicated when to yell, in step S150. For example, the voice “5, 4, 3, 2, 1, please shout at me!” is played, or a counting-down image is displayed, or both of the above voices and images are used. Then, as the user yells at the yelling abreaction unit 140 of the emotion abreaction unit 100, in step S155, the magnitude of the volume of the user's yelling at the abreaction unit 140 is measured.

Furthermore, regardless of whether the user is knocking or yelling, the voices of “Sorry, I was wrong”, “Master, please forgive me”, or another voice that is helpful for the user to abreact the emotions is played synchronously, or otherwise, the picture of a twisted face or another picture that is helpful for the user to abreact the emotions is displayed in images, or both of the above voices and images are used.

If the user has selected to abreact the emotions by doodling, the user is selectively requested to select a built-in image or an externally-input image, such as a photo of an annoying guy, and the image is displayed on the touch screen (for example, the man machine interacting module 130), in step S160. If the user does not input or select an image, the control unit 120 can automatically determine the image to be displayed or determine to be blank on the screen. Then, the user doodles on the touch screen by hands or through an appropriate tool, e.g., a stylus, in step S165.

Then, based on the resulted doodling work, the magnitude of the force and/or the volume, the user is responded through a voice and/or an image, in step S170. The process for responding to the user includes appearing to be suffered or miserable, informing the user about the magnitude of the force or the volume, imitating running away by moving the emotion abreaction device 100 and/or encouraging the user. For example, the voice of “Master, you are terrific”, “Master, have you always being so strong”, “Master, your anger index is XX points”, or another voice that is helpful for the user to abreact emotions, otherwise, an image capable of achieving the same effect is displayed, or moving the body 110 by the moving unit 160 to imitate running away while the user is knocking, yelling, and/or doodling, or using a combination of the above processes.

Then, the user is selectively inquired whether to continue to abreact the emotions or not, in step S180. If the user wants to continue to abreact the emotions, it returns to S130, or jumps directly to the step S145, S155, or S165. If the user does not want to continue to abreact the emotions, the device is turned off, in step S190. Of course, if the user doesn't respond about whether to continue to abreact the emotions or not, the emotion abreaction device 100 may also be set to be automatically turned off after a certain waiting time.

It should be noted that, in the using method of this embodiment, after turning on of the emotion abreaction device 100, i.e., the step S110, the steps S120 to S160 may be skipped to enable the user to directly knock, yell, or doodle (steps S145, S155, S165), thereby providing the user with the most instant and rapid emotion abreaction. The flow chart is not additionally depicted herein.

### Second Embodiment

The second embodiment is similar with the first embodiment, only the difference is described in the second embodiment.

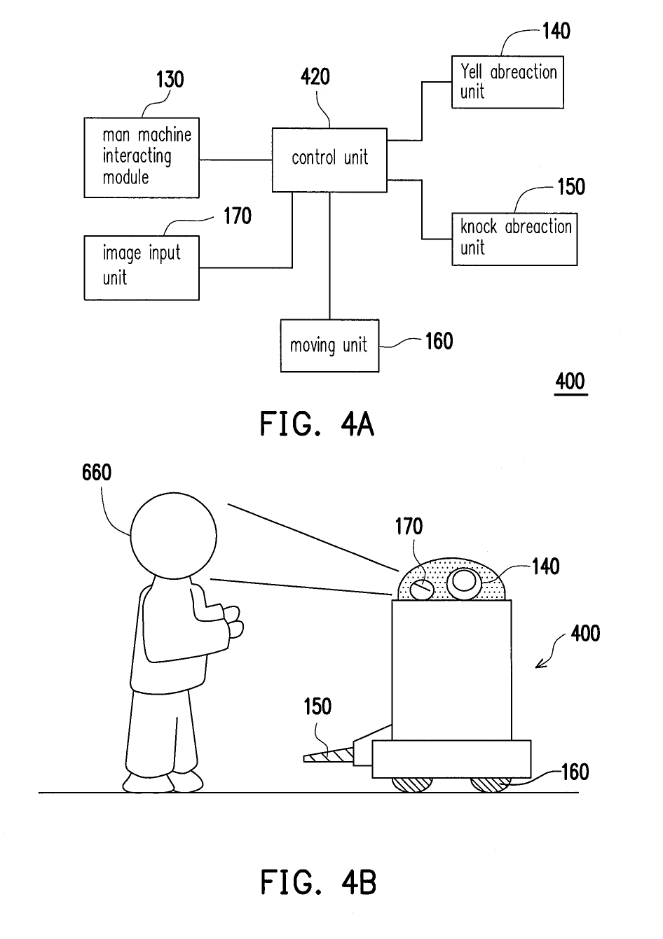

FIGS. 4A and 4B are schematic block diagrams of an emotion abreaction device according to the second embodiment.

Referring to FIG. 4A. The emotion abreaction device 400 includes the control unit 420, the man machine interacting module 130, the yell abreaction unit 140, the knock abreaction unit 150, the moving unit 160, and the image input unit 170. The operations of the man machine interacting module 130, the yell abreaction unit 140, the knock abreaction unit 150, the moving unit 160, and the image input unit 170 are described in the first embodiment, so that they are not repeated in the second embodiment.

The image input unit 170 captures an image of the user 660 (as shown in FIG. 4B), and the control unit 420 executes a face detection procedure on the captured image. In order to do the face detection procedure, a plurality of training images are used to train a classifier, and each of the training images has a light angle of a light source. The training images are grouped into a plurality of angle sets according to a light angle of each of the training images. In particular, the grouping of the training images is used to alleviate the effect of the light angle when executing the dace detection procedure on the first image.

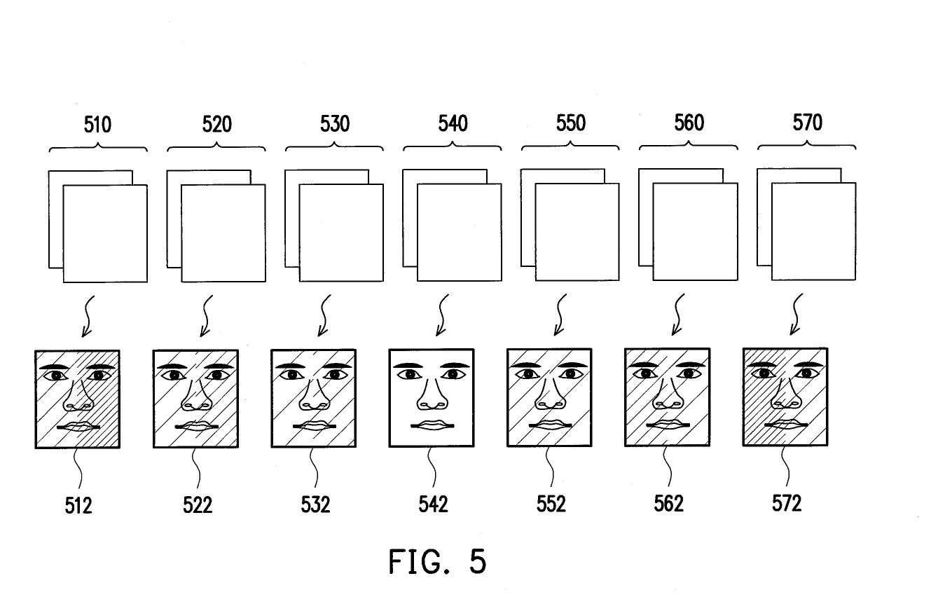

FIG. 5 is a diagram illustrating an example of grouping the training images according to the second embodiment.

Referring to FIG. 5. All the training images are grouped into angle set 510, angle set 520, angle set 530, angle set 540, angle set 550, angle set 560 and angle set 570. It should be noticed that every angle set may contain any number of training images, the disclosure is not limited thereto. All the training images are grouped according to their light angles. For example, the training image 512 in the angle set 510 has a light angle “90”, the training image 522 in the angle set 520 has a light angle “70”, the training image 532 in the angle set 530 has a light angle “50”, the training image 542 in the angle set 540 has a light angle “0”, the training image 552 in the angle set 550 has a light angle “−50”, the training image 562 in the angle set 560 has a light angle “−70”, and the training image 572 in the angle set 580 has a light angle “−90”. Each of the training images has a plurality of pixels and each of the pixels has a grey level. Apparently, the grey levels of the training images are affected by the light angles. For example, the grey levels of the training image 542 are more uniform than that of the training image 512 or that of the training image 572. The grey levels of the pixels in the left side in the training image 572 are smaller than that of the right side, and the grey levels of the pixels in the right side in the training image 512 is smaller than that of the left side. In addition, an intensity of an image changes based on the light angle of the image. The intensity may be represented as an average of grey levels of the pixels of an image. For example, the average of the grey levels of the training image 512 is smaller than that of the training image 522, and the average of the grey levels of the training image 522 is smaller than that of the training image 532. That is, in the embodiment, when an absolute light angle is larger, the intensity of an image is lower. In general, images having the light angle “0” have a better face detection result than images having the other light angles. Therefore, the average of the grey levels of all the training images in the angle set 540 (i.e. a first angle set) is calculated, and this average is assigned as a target grey level. In the embodiment, the target grey level is used to benefit the face detection procedure by the control unit 420.

In other embodiments, the images in the angle set 530 may be used to calculate the target grey level. The light angles may be “30”, “−30” or other values, and all the training images may be grouped into more angle sets or less angle sets. The disclosure is not limited thereto.

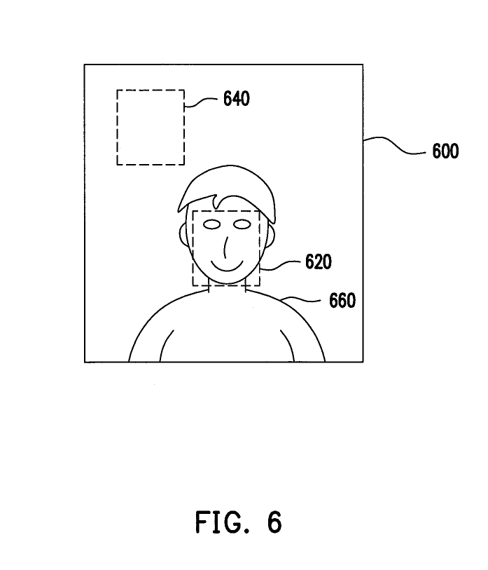

FIG. 6 is a diagram of an example of an image captured by the image input unit 170 according to the second embodiment.

Referring to FIG. 6. When the image input unit 170 captures an image 600 (i.e. a first image), the control unit 420 will execute a face detection procedure on the image 600 to obtain the face part 620. In detail, the image 600 is divided into a plurality of sliding windows, and each of the sliding windows may have different locations and sizes. The control unit 420 executes the face detection procedure on each of the sliding windows to determine if the sliding window is a face part or not. For example, the sliding window 620 is a face part, and the sliding window 640 is not.

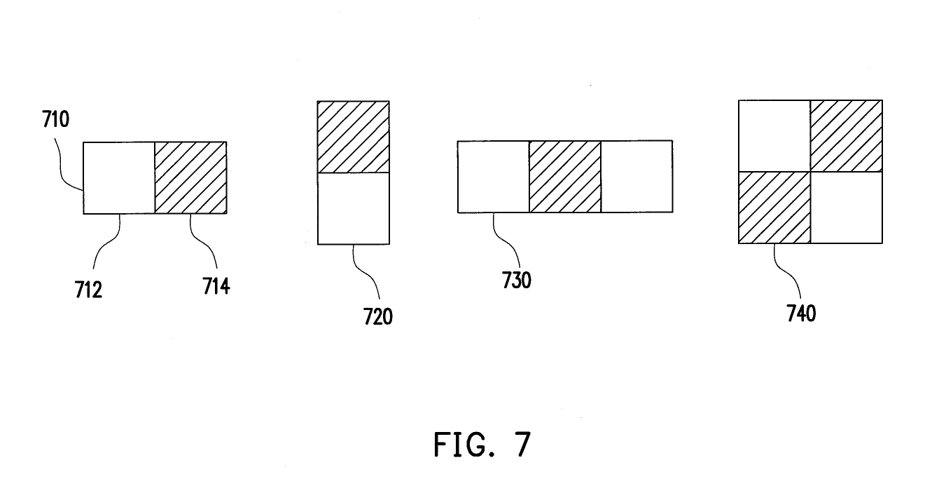

FIG. 7 is a diagram of an example illustrating haar-like features according to the second embodiment.

Referring to FIG. 7. The control unit 720 would extract feature values from each of the sliding windows to execute the face detection procedure. For example, haar-like features 710, 720, 730 and 740 are used by the control unit 420. When extracting the feature value of the haar-like feature 710, the control unit 420 takes the haar-like feature 710 as a mask, and puts the haar-like feature 710 at a location of a sliding window. Then, the control unit 420 calculates the sum of the grey levels of the pixels in the region 712 and the sum of the grey levels of the pixels in region 714. In addition, the subtraction of these two sums is calculated as a feature value by the control unit 420.

In particular, the feature value is adjusted according to the target grey level discussed above by the control unit 720. Take the sliding window 620 as an example, when determining if the sliding window is a face part, all the grey levels of the pixels in the sliding windows 620 are adjusted according to the formula (1) as follows:

$${i}_{ARM} = \frac{t}{Av} \times {i}_{old} , \qquad ( 1 )$$

where i_{old} is a grey level of a pixel in the sliding window 620, t is the target grey level, Av is an average of the grey levels of the pixels in the sliding window 620, and i_{ARM} is an adjusted grey level. Although the formula (1) only defines the adjustment of grey levels, the feature value of a haar-like feature is adjusted as well because a haar-like feature extraction is a linear function (i.e. only summation and subtraction of grey levels). Therefore, in other embodiments, i_{old} is a feature value of a haar-like feature, i_{ARM} is an adjusted feature value of the harr-like feature. After executing the formula (1), the grey levels in a sliding window are closer to the target grey level, which indicates an average grey level of an angle set having a better detection result. In other words, the goal of the formula (1) is to compensate the effect of different light angles in the embodiment.

After adjusting the feature values of the sliding window 620, the control unit 420 may apply a machine learning algorithm to execute a face detection procedure. For example, the control unit 420 may apply AdaBoost (Adaptive Boosting), SVM (Support Vector Machine), or a neural network, but the disclosure is not limited thereto. When determining the sliding window 620 is a face part, the control unit 420 further recognizes the face part to determine if the user 660 is using the emotion abreaction device 400 for the first time.

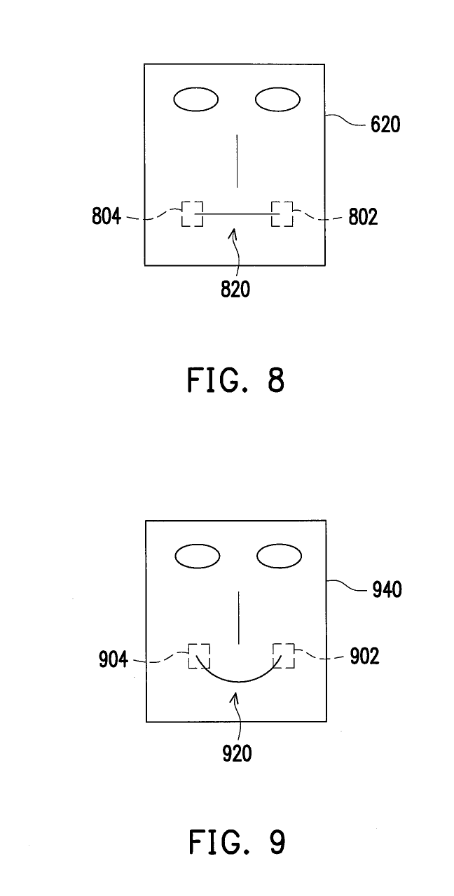

If determining that the user 620 is using the emotion abreaction device 400 for the first time, the control unit 420 will record a baseline profile of the user 660 when the user 660 is in a neutral mood. To be specific, the man machine interacting module display a message to guide the user 660 to stay in a neutral mood, and the yell abreaction unit 140 records a voice signal of the user 660. Then, the yell abreaction unit 140 transmits the voice signal to the control unit 420 as a baseline profile. Alternatively, the knock abreaction unit 150 estimates a magnitude (i.e. a first magnitude) of the user's 660 knocking force when the user 660 is in a neutral mood. Then, the knock abreaction unit 150 transmits the magnitude to the control unit 420 as the baseline profile. In one embodiment, as illustrated in FIG. 8, the control unit 420 obtains the locations (i.e. first locations) of the corners 802, 804 (i.e. first corners) of the mouth 820 (i.e. a first mouth), and takes the locations as the baseline profile. In other words, the baseline profile may include a voice signal, a magnitude of a knocking force, a location of a corner of a mouth, or all of them.

If the control unit 420 determines the user 660 is not using the emotion abreaction device 400 for the first time, the control unit 420 will obtains a current profile of the user 660. The current profile may include a magnitude of a knocking force, a voice signal or a location of a corner of a mouth. For example, when the user 660 is abreacting the emotions through yelling and knocking, the knock abreaction unit 150 estimates a magnitude (i.e. a second magnitude) of the user's 660 knocking force, and the yell abreaction unit 140 records a voice signal (i.e. a second voice signal) of the user 660. In addition, the second magnitude and the second voice signal are transmitted to the control unit 420 as the current profile. In one embodiment, as illustrated in FIG. 9, the control unit 420 obtains the locations (i.e. second locations) of the corners 902, 904 (i.e. second corners) of the mouth 920 (i.e. second mouth), and takes the second locations as the current profile.

After obtaining the current profile, the control unit 420 would generate a happiness level by comparing the baseline profile with the current profile. For example, control unit 420 compares the first magnitude and second magnitude, or the first voice signal and the second voice signal to estimate how angry the user 660 is. Consequently, control unit 420 may control the man machine interacting module 130 to respond to the user 620 according to how angry the user 660 is. On the other hand, the control unit 420 compares the first locations of the corners 802 and 804, and the second locations of the corners 902 and 904 to determine if the user 660 has a smile on his/her face. For example, after the user 660 abreacts the emotion, the corners 902 and 904 are relatively higher than the first locations of the corners 802 and 804, so that the control unit 420 detects that the user 600 is smiling, that is represented as a high happiness level.

During recording the baseline profile and the current profile, the control unit 420 needs to detect the corners 802 and 804 of the mouth 820, and the corners 902 and 904 of the mouth 920 to get their locations. In the embodiment, a symmetrical rectangle is provided to detect corners of a mouth.

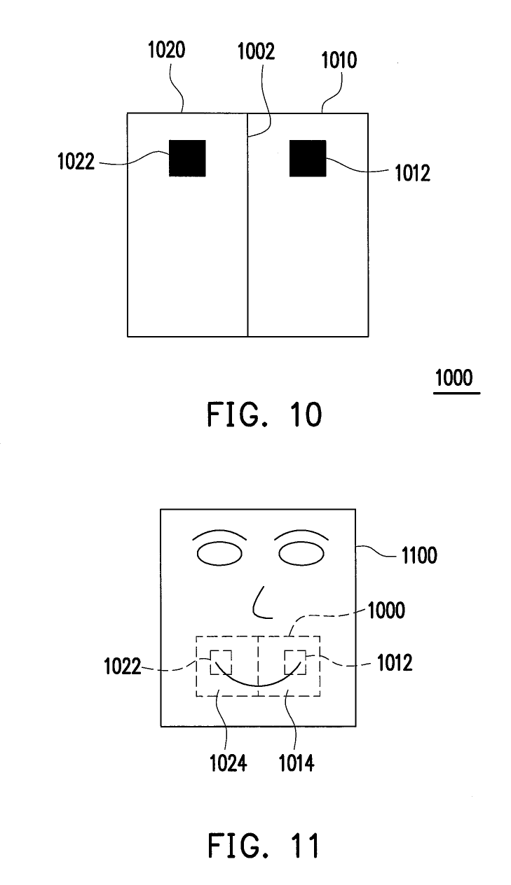

FIG. 10 is a diagram illustrating an example of a symmetrical rectangle according to the second embodiment.

Referring to FIG. 10. The symmetrical rectangle 1000 includes an axis 1002, and the two sides of the axis 1002 are regions 1010 and 1020. The symmetrical rectangle 1000 also includes two sub-rectangles 1012 and 1022, which are located at the two sides of the axis 1002 symmetrically. Since eyes or corners of a mouth are symmetrical on a human face, the symmetrical rectangle 1000 is particularly used to detect such symmetrical facial features.

FIG. 11 is a diagram illustrating an example of detecting corners of a mouth by the symmetrical rectangle according to the second embodiment.

Referring to FIG. 11. When detecting corners of a mouth in the face part 1100, the control unit 420 may predict the mouth is located at a lower position of the face part 1100. Therefore, the control unit 420 starts from the lower position, takes the symmetrical rectangle 1000 as a mask, and estimates a feature value of the symmetrical rectangle 1000. In detail, the grey levels of the pixels in the sub-rectangles 1012 and 1022 are added into a first value, and the grey levels of the pixels in the other regions 1014 and 1024 in the symmetrical rectangle 1000 are added into a second value. In addition, the subtraction between the first value and the second value is calculated as the feature value of the symmetrical rectangle 1000. The control unit 420 determines that the sub-rectangles 1012 and 1022 are located on corners of a mouth if the feature value is larger than a threshold. If the output of the symmetrical rectangle 1000 is less than a threshold, the control unit 420 may further move symmetrical rectangle 1000 around the face part 1100 to detect the corners of the mouth. Alternatively, the control unit 420 may move the symmetrical rectangle 1000 around and generate a plurality of feature values first, then the corners of a mouth are detected by obtaining the largest feature value.

It should be noticed that the symmetrical rectangle 1100 may be used to detect eyes, ears, or other symmetrical features. In addition, the symmetrical rectangle 1000 may has a different width, a different height, or any number of sub-rectangles. The disclosure is not limited thereto.

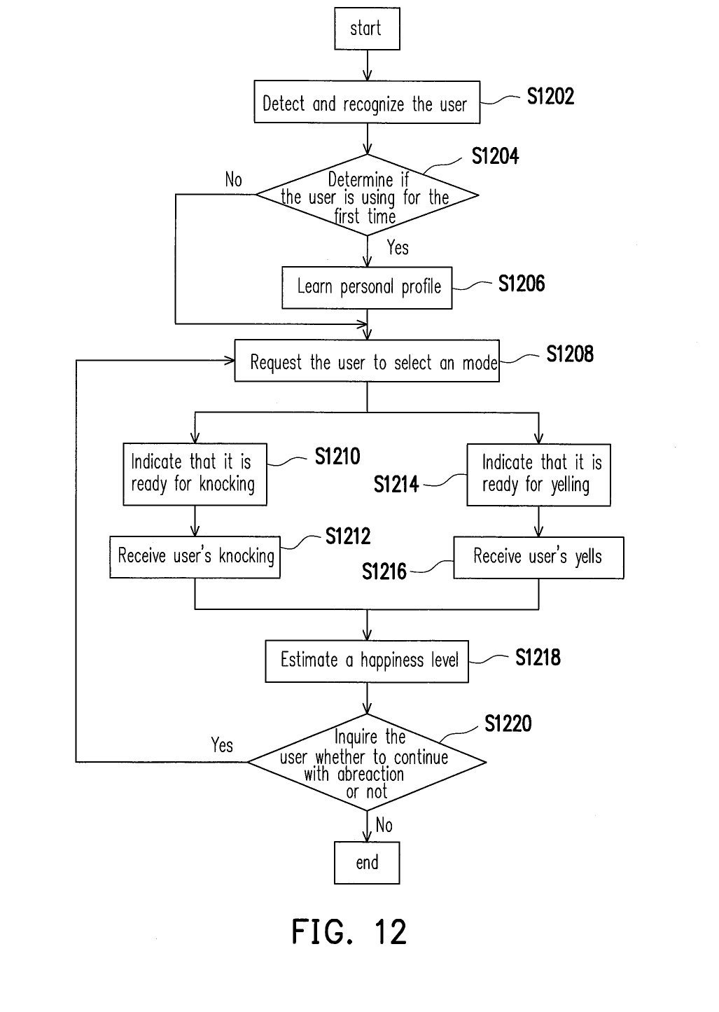

FIG. 12 is a flow chart of a using method for an emotion abreaction device according to the second embodiment.

Referring to FIG. 12. In step S1202, the control unit 420 detects and recognizes the user. For example, control unit 420 may adjusts a feature value of an image (i.e. a first image) according to the target grey level as discussed above and detects a face part of the first image according to the adjusted feature value. According to the result of the detection and the recognition, the control unit 420 may controls the man machine interacting module to greet the user in step S1202.

In step S1204, the control unit 420 determines if the user is using the emotion abreaction device for the first time according to the result of the recognition. If the user is using for the first time, in step S1206, the control unit learns the personal profile (i.e. baseline profile) of the user. For example, the baseline profile may include a voice signal, a magnitude of a knocking, or the location of a corner of a mouth.

If the user is not using the emotion abreaction device for the first time or after step S1206, in step S1208, the control unit 420 controls the man machine interacting module 130 to request the user to select an mode. For example, the mode is selected from a yelling mode, and a knocking mode.

In step S1210, the man machine interacting module 130 indicates that is ready for knocking. In step S1212, the knock abreaction unit 150 receives a user's knocking, and estimates a magnitude of the knocking.

In step S1214, the man machine interacting module 130 indicate that it is ready for yelling. In step S1216, the yell abreaction unit 140 receives a user's yells and records a voice signal of the yells.

In step S1218, the control unit 420 estimates a happiness level by comparing the baseline profile and the current profile. For example, the current profile may include the voice signal recorded in step S1216, a magnitude estimated in step S1212, or a location of a corner of a mouth.

In step S1220, the man machine interacting module 130 inquires the user whether to continue with abreaction or not. If the user decides to continue, go back to step S1208, if not, the method ends.

However, all the steps in FIG. 12 are described in detail above, so that they will not be repeated.

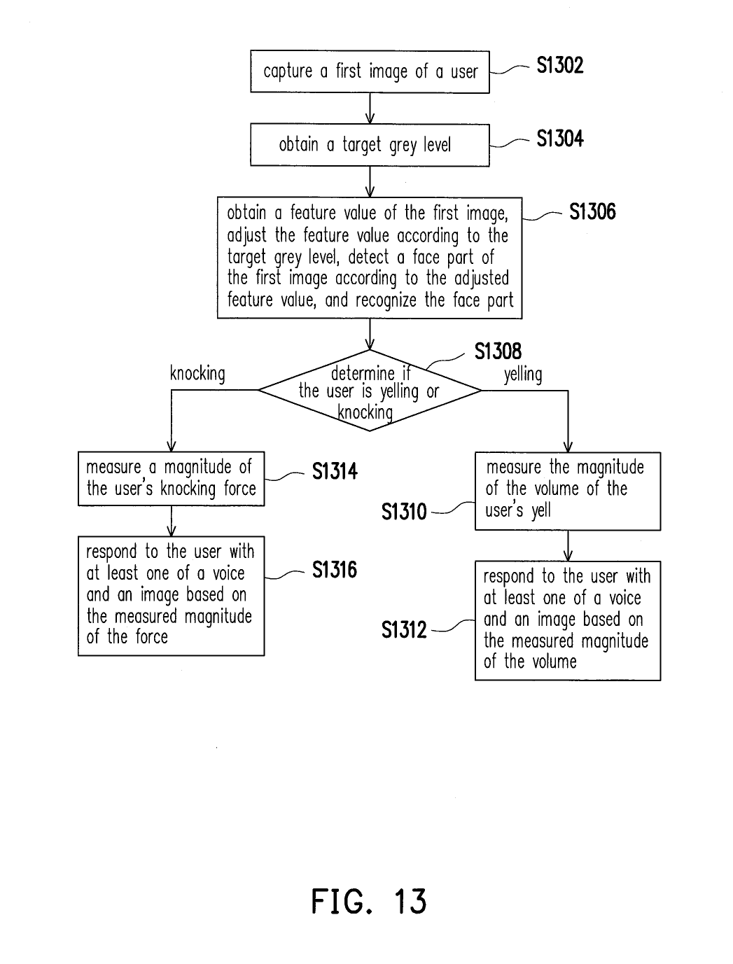

FIG. 13 is a flow chart of a using method for an emotion abreaction device according to one embodiment.

Referring to FIG. 13. In step S1302, the image input unit 170 captures a first image of a user. In step S1304, the control unit 420 obtains a target grey level, wherein a plurality of training images are grouped into a plurality of angle sets according to a light angle of each of the training images, and the target grey level is obtained according to an average grey level of one of the angle sets. In step S1306, the control unit 420 obtains a feature value of the first image, adjusts the feature value according to the target grey level, detects a face part of the first image according to the adjusted feature value, and recognizes the face part. In step S1308, the control unit 420 determines if the user is yelling or knocking.

If the user is yelling, in step S1310, the yell abreaction unit 140 measures the magnitude of the volume of the user's yell. In step S1312, the man machine interacting module 130 respond to the user with at least one of a voice and an image based on the measured magnitude of the volume.

If the user is knocking, in step S1314, the knock abreaction unit 150 measures a magnitude of the user's knocking force. In step S1316, the man machine interacting module 130 responds to the user with at least one of a voice and an image based on the measured magnitude of the force.

However, all the steps in the FIG. 13 are described above, so that they will not be repeated again.

In view of the above, the emotion abreaction device of one embodiment of the present disclosure enables the user to abreact the emotions through a furious means of knocking and/or yelling, and has at least one sensor for sensing the magnitude of the force and/or the volume to respond to the user accordingly. Furthermore, a feature value is adjusted to alleviate the effects of different light angles and to improve the detecting result. In the using method of the emotion abreaction device of one embodiment of the present disclosure, the baseline profile and the current profile are obtained. By comparing the baseline profile and the current profile, a happiness level of a user is estimated accurately, and the emotion abreaction device may appropriately responds to the user. Thus, it enables the user to deeply feel the bi-directional interaction scenario. Therefore, it provides an appropriate and harmless process for abreaction, reduce social problems, and improve life quality, and enable users to achieve a complete abreaction in the aspects of both physiology and psychology.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. An emotion abreaction device, comprising:
a body;
a control unit, disposed in the body;
a man machine interacting module, disposed in the body and electrically connected to the control unit, for a user to select an emotion abreaction mode to the control unit;
an emotion abreaction unit, disposed in the body and electrically connected to the control unit, having at least one sensor to measure force and/or volume, for the user to abreact through at least one way of knocking and yelling, wherein the emotion abreaction unit transfers a sensing result to the control unit, and the control unit controls the man machine interacting module to respond to the user with at least one of a voice and an image based on the sensing result; and
an image input unit, disposed in the body and electrically connected to the control unit, configured to capture a first image of the user,
wherein a plurality of training images are grouped into a plurality of angle sets according to a light angle of each of the training images, and the control unit obtains a target grey level according to an average grey level of one of the angle sets, wherein an intensity of each of the training images changes based on the light angles,
wherein the control unit obtains a feature value of the first image, adjusts the feature value according to the target grey level, detects a face part of the first image according to the adjusted feature value, and recognizes the face part.

2. The emotion abreaction device as claimed in claim 1, further comprising a moving unit, disposed in the body and electrically connected to the control unit, wherein the control unit controls the moving unit to move the body based on the sensing result.

3. The emotion abreaction device as claimed in claim 1, wherein the man machine interacting module comprises a voice control interface, for the user to interact with the control unit through voices.

4. The emotion abreaction device as claimed in claim 1, wherein the man machine interacting module comprises a screen and a command input device, wherein the screen is used to display a second image.

5. The emotion abreaction device as claimed in claim 1, wherein the man machine interacting module comprises a touch screen used to display a second image.

6. The emotion abreaction device as claimed in claim 1, wherein the first image comprises a plurality of pixels, and each of the pixels comprises a grey level,
wherein the control unit divides the first image into a plurality of sliding windows, and adjusts the feature value according to the formula (1) as follows:
$${i}_{ARM} = \frac{t}{Av} \times {i}_{old} , \qquad ( 1 )$$
where i_{old} is the feature value which represents one of the grey levels of the pixels in a first sliding window of the sliding windows, t is the target grey level, Av is an average of the grey levels of the pixels in the first sliding window, and i_{ARM} is the adjusted feature value.

7. The emotion abreaction device as claimed in claim 1, wherein the control unit determines if the user is using the emotion abreaction device for a first time according to the face part,
wherein if the user is using the emotion abreaction device for the first time, the man machine interacting module records an baseline profile of the user when the user is in an neutral mood,
if the user is not using the emotion abreaction device for the first time, the control unit obtains a current profile of the user, and generates a happiness level by comparing the baseline profile with the current profile.

8. The emotion abreaction device as claimed in claim 7, wherein the baseline profile includes a first location of a first corner of a first mouth, a first voice signal of the user, or a first magnitude of the user's knocking force when the user is in the neutral mood,
wherein the current profile includes a second location of a second corner of a second mouth, a second voice signal of the user, or a second magnitude of the user's knocking force when the user is not using the emotion abreaction device for the first time.

9. The emotion abreaction device as claimed in claim 8, wherein the control unit uses a symmetrical rectangle to detect the first corner of the first mouth or the second corner of the second mouth, wherein the symmetrical rectangle includes an axis and a plurality of sub-rectangles, and the sub-rectangles are located at two sides of the axis symmetrically.

10. The emotion abreaction device as claimed in claim 1, wherein the control unit is configured to automatically turn on or off the emotion abreaction device upon detecting the user's approaching or departing.

11. A using method of an emotion abreaction device, comprising:
capturing a first image of a user;
obtaining a target grey level, wherein a plurality of training images are grouped into a plurality of angle sets according to a light angle of each of the training images, and the target grey level is obtained according to an average grey level of one of the angle sets, wherein an intensity of each of the training images changes based on the light angles;
obtaining a feature value of the first image, adjusting the feature value according to the target grey level, detecting a face part of the first image according to the adjusted feature value, and recognizing the face part;
when the user is knocking an emotion abreaction unit of the emotion abreaction device, measuring a magnitude of the user's knocking force;
responding to the user with at least one of a voice and an image based on the measured magnitude of the force;
when the user is yelling at the emotion abreaction unit of the emotion abreaction device, measuring the magnitude of the volume of the user's yell; and
responding to the user with at least one of a voice and an image based on the measured magnitude of the volume.

12. The using method of the emotion abreaction device as claimed in claim 11, further comprising requesting the user to select at least one emotion abreaction mode from knocking and yelling, after the emotion abreaction device is turned on and before the magnitude of the knocking force or the volume of the yelling of the user are measured.

13. The using method of the emotion abreaction device as claimed in claim 12, further comprising indicating the user about when to knock, once the user has selected knocking.

14. The using method of the emotion abreaction device as claimed in claim 12, further comprising indicating the user about when to yell, once the user has selected yelling.

15. The using method of the emotion abreaction device as claimed in claim 12, wherein the process for the user to select an emotion abreaction mode comprises providing voice commands, pressing a key of the emotion abreaction device, or using a touch screen of the emotion abreaction device.

16. The using method of the emotion abreaction device as claimed in claim 11, wherein the process for turning on the emotion abreaction device comprises manually turning on the emotion abreaction device by the user or automatically turning on upon sensing the approaching of the user.

17. The using method of the emotion abreaction device as claimed in claim 11, further comprising greeting the user with at least one of a voice and an image immediately after the emotion abreaction device is turned on.

18. The using method of the emotion abreaction device as claimed in claim 11, further comprising providing a touch screen of the emotion abreaction device for the user to doodle thereon.

19. The using method of the emotion abreaction device as claimed in claim 18, further comprising requesting the user to select or input a second image to be displayed on the touch screen after the emotion abreaction device is turned on and before the user starts to doodle.

20. The using method of the emotion abreaction device as claimed in claim 11, further comprising inquiring the user whether to continue abreacting or not and enabling the user to abreact once again or turning off based on the user's command after responding to the user.

21. The using method of the emotion abreaction device as claimed in claim 11, wherein the process for responding to the user comprises at least one of appearing to be suffered or miserable, informing the user about the magnitude of the force or volume, imitating running away by moving the emotion abreaction device, and encouraging the user.

22. The using method of the emotion abreaction device as claimed in claim 11, wherein the first image comprises a plurality of pixels, and each of the pixels comprises a grey level, and the step of adjusting the feature value according to the target grey level comprises:
dividing the first image into a plurality of sliding windows, and adjusting the feature value according to the formula (1) as follows:
$${i}_{ARM} = \frac{t}{Av} \times {i}_{old} , \qquad ( 1 )$$
where i_{old} is the feature value which represents one of the grey levels of the pixels in a first sliding window of the sliding windows, t is the target grey level, Av is an average of the grey levels of the pixels in the first sliding window, and i_{ARM} is the adjusted feature value.

23. The using method of the emotion abreaction device as claimed in claim 11, further comprising:
determining if the user is using the emotion abreaction device for a first time according to the face part;
if the user is using the emotion abreaction device for the first time, recording an baseline profile of the user when the user is in an neutral mood; and
if the user is not using the emotion abreaction device for the first time, obtaining a current profile of the user, and generating a happiness level by comparing the baseline profile with the current profile.

24. The using method of the emotion abreaction device as claimed in claim 23, wherein the baseline profile includes a first location of a first corner of a first mouth, a first voice signal of the user, or a first magnitude of the user's knocking force when the user is in the neutral mood,
wherein the current profile includes a second location of a second corner of a second mouth, a second voice signal of the user, or a second magnitude of the user's knocking force when the user is not using the emotion abreaction device for the first time.

25. The using method of the emotion abreaction device as claimed in claim 24, furthering comprising:
using a symmetrical rectangle to detect the first corner of the first mouth or the second corner of the second mouth, wherein the symmetrical rectangle includes an axis and a plurality of sub-rectangles, and the sub-rectangles are located at two sides of the axis symmetrically.
